(19) United States
(12) Patent Application Publication
(10) Pub. No.: US 2012/0013479 A1
(43) Pub. Date: Jan. 19, 2012

(54) LED SYSTEM AND DRIVING DEVICE WITH ERROR DETECTION, AND ERROR DETECTION MODULE THEREOF

(75) Inventors: Chun-Kong CHAN, Taipei County (TW); Yi-Ping HOU, Taipei County (TW)

(73) Assignee: LIEN CHANG ELECTRONIC ENTERPRISE CO., LTD., TAIPEI COUNTY (TW)

(21) Appl. No.: 12/837,706

(22) Filed: Jul. 16, 2010

(51) Int. Cl. G09F 9/33

(52) U.S. Cl. 340/815.45

(57) ABSTRACT

A LED system and driving device with error detection and an error detection module thereof is disclosed. In which, through the detection of the error detection module, the errors associated with the LED module and the driving circuit may be detected. If the errors are detected, the error detection module may output a determination signal to the control unit so that the LED system could be protected from damages.

### BACKGROUND OF THE INVENTION

1. Field of the Invention

The present invention relates to an error detection module of a Light Emitting Diode (LED) system and driving device; in particular, to a LED system and driving device with error detection utilizing a high voltage error detection module to determine whether any errors occur in the LED module and the driving device.

2. Description of Related Art

Rapid development in Light Emitting Diode (LED) technologies has spawned a variety of applications of LED in various fields; e.g., display screens or lighting apparatus and the like. Because of the widespread applications of LED, how to ensure the proper operation of LED has been one of the issues that need to be carefully handled.

Short-circuit often causes damages to the LED module as the result of the heat generated accordingly. Absent proper detection and protection measures, the short-circuited LED module could even cause fire. Plus, when the driving circuit of the LED module does not operate properly such as being shut down or partially malfunctioning, unnecessary waste of energy may result when no such detection/protection measure for the LED module is in place.

### SUMMARY OF THE INVENTION

The present invention is to provide a Light Emitting Diode (LED) system and driving device with error detection as well as an error detection module, thereby detecting whether any short-circuits in the LED module or whether the driving circuit operates normally.

To achieve the aforementioned objectives, in accordance with one embodiment of the present invention, an error detection module of a LED system and driving device is provided, wherein the error detection module is electrically coupled to a LED module, a driving circuit of the LED module and a control module, thereby providing a detection signal to the error detection module before a determination signal to the control module may be generated. The control module is electrically connected to the LED module and the driving circuit for receiving the determination signal and generating a control signal based on the received determination signal.

The error detection module includes a high voltage determination unit and a reverse current protection unit. The high voltage determination unit is used to compare the detection signal with a reference signal; suppose the detection signal is greater than the reference signal in voltage level, the determination signal will be outputted. The reverse current protection unit is electrically coupled to the high voltage determination protection unit thereby preventing the current from flowing back to the LED module and the driving circuit.

Herein the high voltage determination unit may be a comparator, and the reverse current protection unit may include a field effect transistor and a transistor control unit. The transistor control unit controls the conductivity of the field effect transistor thereby preventing the current from flowing back to the LED module and the driving circuit.

The summary illustrated hereinbefore as well as the embodiments set forth as below are all for further explaining the technical means and achieves effects of the present invention; whereas the embodiments and drawings described in the present disclosure are simply directed to be referential, rather than being intended to limit the present invention.

### BRIEF DESCRIPTION OF THE DRAWINGS

FIG. 1 shows a block diagram for an embodiment of the LED system with error detection according to the present invention; and

FIG. 2 shows a circuit diagram for an embodiment of the error detection module in the LED system and driving device with error detection according to the present invention.

### DETAILED DESCRIPTION OF THE PREFERRED EMBODIMENTS

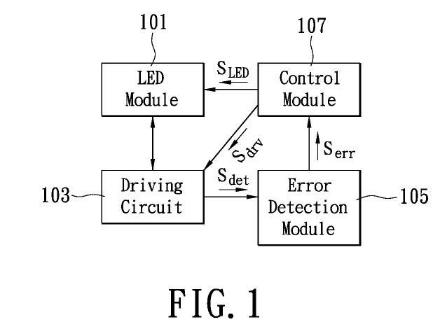

FIG. 1 is a block diagram illustrating a Light Emitting Diode (LED) system with error detection according to one embodiment of the present invention. The LED system includes a LED module 101 having a LED, a driving circuit 103, an error detection module 105 and a control module 107.

The LED module 101 is an illuminating component featuring higher lighting efficiency than conventional light sources and also a longer lifespan. The driving circuit 103 is electrically coupled to the LED module 101 for driving the LED module 101 and adjusting the brightness of the LED module 101 based on user's settings or in accordance with environmental conditions.

The error detection module 105 is electrically coupled to the driving circuit 103, which may operate to acquire a detection signal S_{det} from the driving circuit 103 and accordingly determine whether the driving circuit 103 operates normally, or any short-circuit in the LED module 101; if the determination indicates that driving circuit 103 operates abnormally or the LED module 101 is short-circuited, a determination signal Sₑᵣᵣ is outputted representing the occurrence of errors in the circuit. Herein the detection signal S_{det} may be a voltage signal of a certain potential. Suppose the voltage levels of the voltage signals differ when the driving circuit 103 operates normally and abnormally, the error detection module 105 may accordingly decide that the errors may occur on the part of the circuitry before outputting the determination signal Sₑᵣᵣ to the control module 107.

The control module 107 is electrically coupled to the LED module 101, the driving circuit 103 and the error detection module 105. Upon the receipt of the determination signal Sₑᵣᵣ issued by the error detection module 105, the control module 107 outputs a control signal S_{LED} or S_{drv} so as to interrupt operations of the LED system to prevent damages in the circuitry or unnecessary waste of electrical power.

Nevertheless, it goes without saying that the protective safety measures performed by the control module 107 mentioned as above can be optionally configured in accordance with the user's requirements, herein not being restricted in any sense. For example, in addition to the interruption to the LED system, in another implementation a warning signal may be sent to an electronic device, such as a cellular phone or a personal computer, for reminding the user of the current status in the LED system.

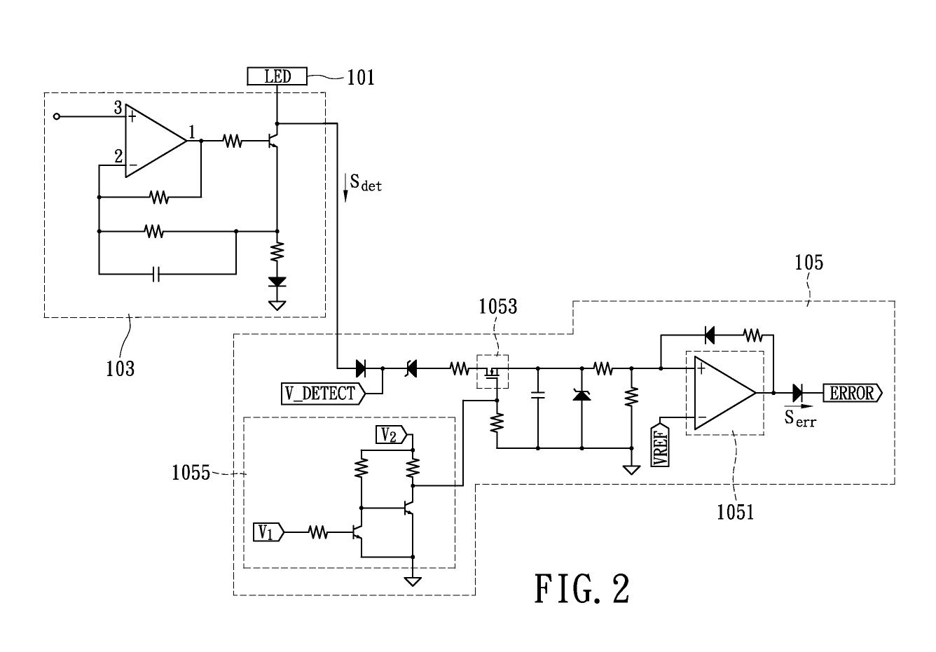

Refer next to FIG. 2, wherein a circuit diagram for an embodiment of the error detection module in the LED system and driving device with error detection according to the present invention is shown, which as depicted comprises a LED module 101, a driving circuit 103 and an error detection module 105. In the present embodiment, the driving circuit 103 is electrically coupled to the LED module 101 thereby controlling and adjusting the brightness of the LED module 101. The error detection module 105 is electrically coupled to the LED module 101 and the driving circuit 103 in order to receive the detection signal S_{det} and accordingly determine whether any errors take place in the LED module 101 or the driving circuit 103.

The error detection module 105 includes a high voltage determination unit 1051 and a reverse current protection unit. The high voltage determination unit 1051 may be a comparator, which compares the detection signal S_{det} with a reference signal VREF in order to output a determination signal Sₑᵣᵣ.

In the present embodiment, if the driving circuit 103 does not operation normally (e.g., malfunction or turn off), the voltage level in the detection signal S_{det} may climb. And thus the receipt of the detection signal S_{det} and setting the voltage level of the reference signal VREF to be lower than the voltage level of the detection signal when the driving circuit 103 operates normally may implement a mechanism that is capable of determining if there is any occurrence of malfunctioning in the driving circuit 103 or the LED module 101. thereby making the reference signal VREF than the voltage under normal operations, in the event that the driving circuit 103 operates abnormally, it is thus possible to output the determination signal Sₑᵣᵣ indicting the existence of errors by means of the high voltage determination unit 1051. For example, when the driving circuit 103 or the LED module 101 operates normally the detection signal S_{det} may be around 10 Volts; but as the driving circuit 103 is OFF, the detection signal S_{det} may dramatically climb to 60 Volts. Therefore, the high voltage determination unit 1051 may determine the occurrence of errors according to the reference signal lower than 10 Volts.

Alternatively, in case that a certain portion in the LED module 101 may be short-circuited, the voltage in the detection signal S_{det} may increase as well. Therefore, the high voltage determination unit 1051 may be configured to determine the existence of short-circuit in the LED module 101 according to the predetermined and configurable voltage level of the reference signal. It is worth noting that the determination signal may be outputted only after a predetermined number of the LED modules 101 are short-circuited. In other words, when the number of the LED modules 101 that are short-circuited does not exceed the predetermined number, no detection signal may be outputted. To achieve this, the voltage level of the reference signal may be configured so that the high voltage determination unit 1051 may not output the determination signal until after the voltage level of the reference signal has been reached as the result of the short-circuits of the LED modules. For example, the voltage in the detection signal S_{det} is 10 Volts when the entire LED modules 101 operate normally, and the voltage of the detection signal may rise 3 to 5 Volts with each short-circuited LED. When the determination signal Sₑᵣᵣ is configured to be generated only after more than three (3) LEDs are short-circuited, the voltage in the reference signal VREF may be modified so that when the voltage level of the determination signal reaches the voltage level of the modified reference signal the determination signal could be outputted.

The reverse current protection unit has a field effect transistor 1053 and a transistor control unit 1055, in which the field effect transistor 1053 is used to prevent the current from flowing back to the driving circuit 103 and the LED module 101 via the error detection module 105, thereby further protecting the driving circuit 103 and the LED module 101 from damages.

The voltages V₁ and V₂ may be the driving voltages of the integral LED system, and the field effect transistor 1053 may be conducted when both of the voltages V₁ and V₂ are normally supplied (that is, the LED system is in operation), further causing the error detection module 105 to detect any presence of error. In other words, when any of the voltages V₁ and V₂ is not normally supplied, the LED system may not be in operation, requiring no error detection. Thus, the field effect transistor 1053 may not be conducted and the error detection module 105 may be opened without unexpected current flowing back to the driving circuit 103 and the LED module 101 from the error detection module 105, thereby improving stability of the circuitry.

The aforementioned descriptions set forth the illustrations for the embodiments and drawings of the present invention. The scope of the present invention should be based on the following claims, and all changes, alternation or substitutions that those skilled ones in the art can conveniently consider without departing from the field of the present invention should be deemed as being encompassed by the scope of the present invention.

What is claimed is:

1. A Light Emitting Diode (LED) driving device with error detection, electrically coupled to a LED module having a LED, comprising:
a driving circuit, which drives the LED module and adjusts a brightness of the LED module;
an error detection module electrically coupled to the LED module and the driving circuit, for acquiring a detection signal and accordingly generating a determination signal, wherein the error detection module comprises:
a high voltage determination unit, which is electrically coupled to the LED module and the driving circuit, for comparing the detection signal with a reference signal, and if the detection signal is greater than the reference signal in a voltage level the high voltage determination unit outputs the determination signal; and
a control module, which is electrically coupled to the error detection module, for receiving the determination signal and generating a control signal based on the determination signal;
wherein the error detection module acquires the detection signal to determine whether the LED module is short-circuited or the driving circuit operates normally, and if the LED module is short-circuited or the driving circuit operates abnormally, the error detection module outputs the determination signal to the control module thereby allowing the control module to generate the control signal to control operations of the LED module and the driving device.

2. The Light Emitting Diode (LED) driving device with error detection according to claim 1, wherein the high voltage determination unit is a comparator.

3. The Light Emitting Diode (LED) driving device with error detection according to claim 1, wherein the error detection module further includes:
a reverse current protection unit, which is electrically coupled to the LED module and the driving circuit, for preventing a current from flowing back to the LED module and the driving circuit through the error detection module.

4. The Light Emitting Diode (LED) driving device with error detection according to claim 3, wherein the reverse current protection unit includes a field effect transistor electrically coupled to the driving circuit and the LED module and a transistor control unit electrically coupled to the field effect transistor, wherein the transistor control unit controls a conductivity of the field effect transistor thereby preventing the current from flowing back to the LED module and the driving circuit through the error detection module.

5. An error detection module of a Light Emitting Diode (LED) system and driving device, which is electrically coupled to a LED module having a driving circuit and a LED, wherein the error detection module acquires a detection signal and accordingly generates a determination signal, comprising:
a high voltage determination unit, which compares the detection signal with a reference signal, wherein if the detection signal is greater than the reference signal in a voltage level the high voltage determination unit outputs the determination signal; and
a reverse current protection unit, which is electrically coupled to the high voltage determination unit, for preventing a current from flowing back to the LED module and the driving circuit.

6. The error detection module of a Light Emitting Diode (LED) system and driving device according to claim 5, wherein the high voltage determination unit is a comparator.

7. The error detection module of a Light Emitting Diode (LED) system and driving device according to claim 5, wherein the reverse current protection unit includes a field effect transistor electrically coupled to the driving circuit and the LED module and a transistor control unit electrically coupled to the field effect transistor, wherein the transistor control unit controls a conductivity of the field effect transistor thereby preventing the current from flowing back to the LED module and the driving circuit through the error detection module.

8. A Light Emitting Diode (LED) system with error detection, comprising:
a LED module having a LED;
a driving circuit, which is electrically coupled to the LED module, for driving the LED module and adjusting a brightness of the LED module;
an error detection module, which is electrically coupled to the LED module and the driving circuit, for acquiring a detection signal and accordingly generating a determination signal, wherein the LED module comprises:
a high voltage determination unit, which is electrically coupled to the LED module and the driving circuit, for comparing the detection signal with a reference signal, wherein if the detection signal is greater than the reference signal in a voltage level the high voltage determination unit outputs the determination signal; and
a control module, which is electrically coupled to the error detection module, for receiving the determination signal and generating a control signal based on the determination signal;
wherein the error detection module acquires the detection signal to determine whether the LED module is short-circuited or the driving circuit operates normally, and if the LED module is short-circuited or the driving circuit operates abnormally, the error detection module outputs the determination signal to the control module thereby allowing the control module to generate the control signal to control operations of the LED module and the driving device.

9. The Light Emitting Diode (LED) system with error detection according to claim 8, wherein the error detection module further includes:
a reverse current protection unit, which is electrically coupled to the LED module and the driving circuit, for preventing the current from flowing back to the LED module and the driving circuit through the error detection module.

10. The Light Emitting Diode (LED) system with error detection according to claim 9, wherein the reverse current protection unit includes a field effect transistor electrically coupled to the driving circuit and the LED module and a transistor control unit electrically coupled to the field effect transistor, and the transistor control unit controls a conductivity of the field effect transistor thereby preventing a current from flowing back to the LED module and the driving circuit through the error detection module.
